(19) United States
(12) Patent Application Publication
(10) Pub. No.: US 2020/0004309 A1
(43) Pub. Date: Jan. 2, 2020

(54) ELECTRONIC DEVICE

(71) Applicant: CANON KABUSHIKI KAISHA, Tokyo (JP)

(72) Inventors: Hiroshi Moritomo, Tokyo (JP); Takashi Morii, Yokohama-shi (JP)

(21) Appl. No.: 16/456,940

(22) Filed: Jun. 28, 2019

(30) Foreign Application Priority Data
Jul. 2, 2018 (JP) 2018-126358

(51) Int. Cl. G06F 1/26; G06F 1/28

(52) U.S. Cl. CPC G06F 1/266; G06F 1/28

(57) ABSTRACT

An electronic device includes an interface unit to which external devices can be connected, and a control unit. The control unit sets power to a second power greater than a first power after limiting power supplied to the external device to the first power, maintains power supplied to the external device at the second power, in a case where the number of the external devices connected to the interface unit exceeds a predetermined number, and controls power supplied to the external device to be a third power greater than the second power, in a case where the number of the external devices connected to the interface unit is not the predetermined number.

### BACKGROUND

### Field of the Disclosure

Aspects of the disclosure generally relate to an electronic device that can supply power to an external device, a method of controlling the electronic device, or the like.

### Description of the Related Art

Japanese Patent Laid-Open No. 2015-207155 describes a process in which an electronic device detects an external device connection. Japanese Patent Laid-Open No. 2004-341592 describes a method for setting power supplied from an electronic device to an external device.

In Japanese Patent Laid-Open No. 2004-341592, the external device adjusts required power after the external device determines a power supply capability of the electronic device. Therefore, in Japanese Patent Laid-Open No. 2004-341592, there is a possibility that when power to be consumed by the external device exceeds a power supply capability of the electronic device at the time of connection, the power supply will be stopped and the external device will not be able to operate.

### SUMMARY

According to an aspect of the embodiments, a device, a method, a program, or the like that can adjust power supplied to one or more external device(s) from an electronic device are provided.

According to an aspect of the embodiments, there is provided an electronic device comprising: an interface unit to which external devices can be connected; and a control unit that (i) sets power to a second power greater than a first power after limiting power supplied to the external device to the first power, (ii) maintains power supplied to the external device at the second power, in a case where the number of the external devices connected to the interface unit exceeds a predetermined number, and (iii) controls power supplied to the external device to be a third power greater than the second power, in a case where the number of the external devices connected to the interface unit is not the predetermined number.

Further aspects of the embodiments will become apparent from the following embodiments.

### BRIEF DESCRIPTION OF THE DRAWINGS

FIG. 1 is a block diagram for illustrating components of a battery charging system according to a first embodiment.

FIGS. 2A and 2B are views showing the arrangement of pins of a USB Type-C plug connector and receptacle connector.

FIG. 3 is a block diagram for illustrating components of a current control unit 1105.

FIG. 4 is a view for illustrating an example of current settings set by the current control unit 1105.

FIG. 5 is a flowchart for illustrating an exemplary process performed by the battery charging system shown in FIG. 1.

### DESCRIPTION OF THE EMBODIMENTS

Exemplary embodiments, features, and aspects of the disclosure will be described below with reference to the drawings. However, aspects of the disclosure are not limited to the following embodiments.

### First Embodiment

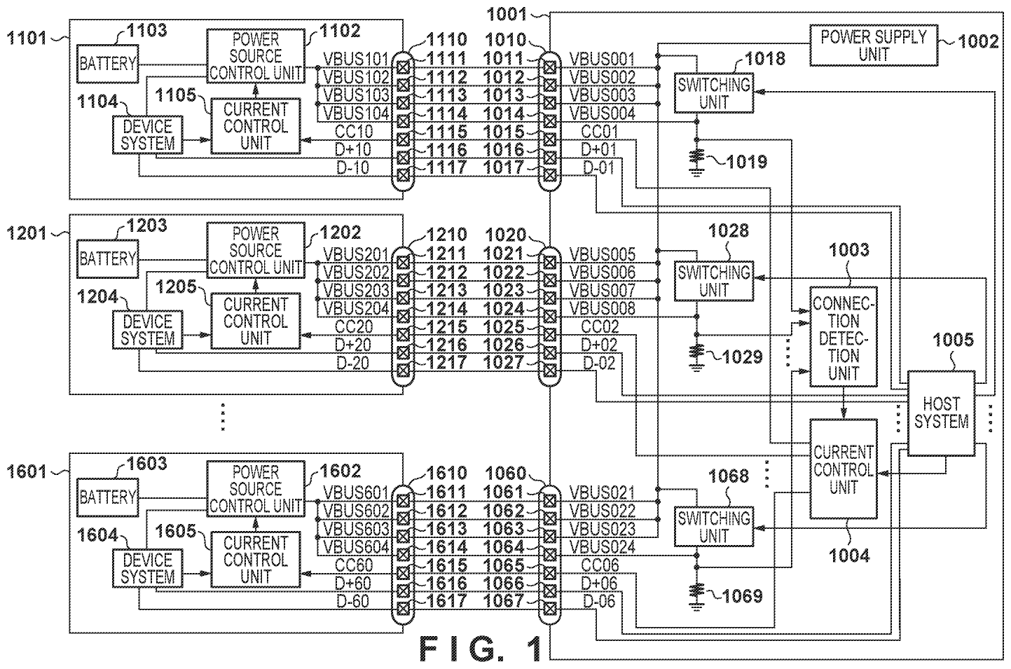

First, with reference to FIG. 1, components of a battery charging system in a first embodiment will be described. However, the components of the battery charging system in the first embodiment are not limited to those shown in FIG. 1.

The battery charging system according to the first embodiment includes a docking station 1001 and wearable cameras 1101, 1201, and 1601. The docking station 1001 is capable of acting as an electronic device such as a PC (personal computer). The docking station 1001 is further operable as a host device for controlling the wearable cameras 1101, 1201 and 1601. The docking station 1001 has interface connectors 1010, 1020 and 1060. The interface connector 1010 can be connected to a wearable camera 1101, which is an exemplary external device. The interface connector 1020 can be connected to a wearable camera 1201, which is an exemplary external device. The interface connector 1060 is connectable to a wearable camera 1601, which is an exemplary external device. The docking station 1001 has a function of communicating with the wearable cameras 1101, 1201, and 1601. Further, the docking station 1001 has a function of supplying power to the wearable cameras 1101, 1201, and 1601, or the like.

The wearable cameras 1101, 1201, and 1601 may be camera-incorporated wearable devices such as glasses, goggles, wristwatches, or the like, or may be an electronic device such as an in-vehicle camera. In the first embodiment, the wearable cameras 1101, 1201, and 1601 all have the same configuration. The wearable cameras 1101, 1201 and 1601 have interface connectors 1110, 1210 and 1610 connectable to the docking station 1001. The wearable cameras 1101, 1201, and 1601 have a function of communicating with the docking station 1001. The wearable cameras 1101, 1201, and 1601 have a function of receiving a power supply from the docking station 1001, or the like.

Next, referring to FIG. 1, components of the docking station 1001 and the wearable cameras 1101, 1201, and 1601 in the first embodiment will be described. However, the components of the battery charging system in the first embodiment are not limited to those shown in FIG. 1.

First, components of the docking station 1001 will be described.

The interface connectors 1010, 1020, and 1060 are all connected to an external device. In the first embodiment, the interface connectors 1010, 1020, and 1060, for example, use plug connectors conforming to USB (Universal Serial Bus) Type-C, but may use a connector conforming to another standard. In the first embodiment, the docking station 1001 can be connected to six external devices using six interface connectors 1010 through 1060. In FIG. 1, three (interface connectors 1010, 1020, and 1060) of the six interface connectors 1010 through 1060 are illustrated. In the first embodiment, the interface connectors 1010, 1020, and 1060 are plug connectors that are assumed to be for direct connection to an external device, but they may be connected via USB Type-C cables (not shown). In the case of cable connections, interface connectors 1010, 1020, and 1060 are receptacle connectors.

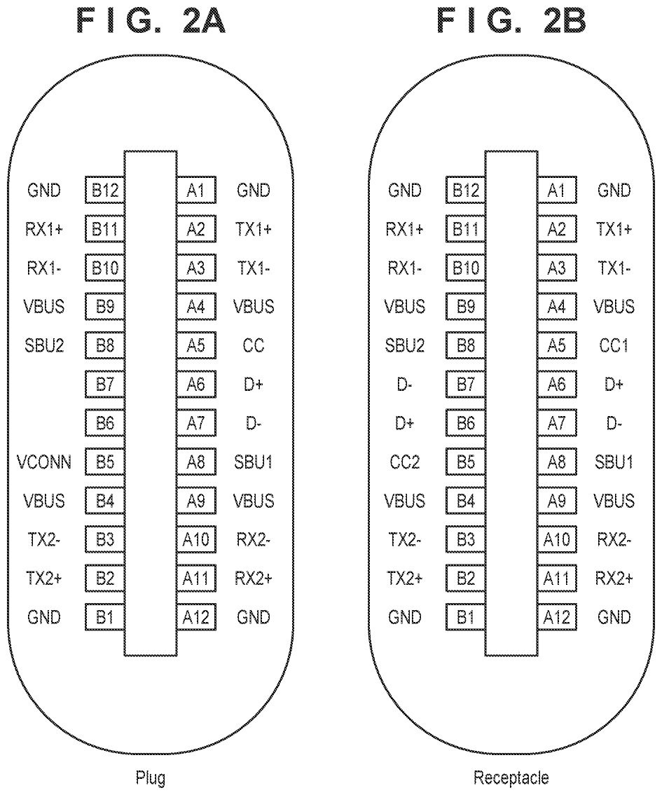

FIG. 2A shows an arrangement of pins of a plug connector conforming to USB Type-C. In the interface connector 1010, VBUS terminals 1011, 1012, 1013, and 1014 are VBUS terminals conforming to USB Type-C. The VBUS terminals 1011, 1012, 1013, and 1014 are referred to as VBUS 001, VBUS 002, VBUS 003, and VBUS 004 in the first embodiment. A CC terminal 1015 is a CC (Configuration Channel) terminal conforming to USB Type-C, and is referred to as CC 01 in the first embodiment. A D+ terminal 1016 is a D+ terminal for USB communication and is referred to as D+01. A D− terminal 1017 is a D− terminal for USB communication, and is referred to as D−01. Similarly, in the interface connector 1020, the VBUS terminals 1021, 1022, 1023, and 1024 are referred to as VBUS 005 through VBUS 008 in the first embodiment. Similarly, in the interface connector 1060, the VBUS terminals 1061, 1062, 1063, and 1064 are referred to as VBUS 021 through VBUS 024 in the first embodiment. CC terminals 1025 and 1065 are referred to as CC 02 and CC 06, respectively, in the first embodiment. D+ terminals 1026 and 1066 are referred to as D+02 and D+06, respectively, in the first embodiment. D− terminals 1027 and 1067 are referred to as D−02 and D−06, respectively, in the first embodiment.

In FIG. 1, a power supply unit 1002 supplies power for operating the docking station 1001 to the components of the docking station 1001, and also supplies power to the wearable cameras 1101, 1201, and 1601.

In the first embodiment, the power supply unit 1002 can supply power of up to 60W. When up to six wearable cameras are connected via the interface connectors 1010, 1020, and 1060, the power supply unit 1002 can supply 10W (5V and 1A) to each of the wearable cameras. It is assumed that the power supply unit 1002 can supply 15W (5V and 3A) to each wearable camera when there are up to four wearable cameras.

A connection detection unit 1003 detects that an external device (wearable camera 1101) is connected to the interface connector 1010. The connection detection unit 1003 detects that an external device (wearable camera 1201) is connected to the interface connector 1020. The connection detection unit 1003 detects that an external device (wearable camera 1601) is connected to the interface connector 1060. The results of detection by the connection detection unit 1003 are constantly notified to a host system 1005. Note, a detailed method for detecting connections performed by the connection detection unit 1003 will be described later.

A current control unit 1004 controls a current for when the wearable camera 1101 receives a power supply from the docking station 1001. The current control unit 1004 controls a current for when the wearable camera 1201 receives a power supply from the docking station 1001. The current control unit 1004 controls a current for when the wearable camera 1601 receives a power supply from the docking station 1001.

The host system 1005 controls the operation of the docking station 1001 and communicates with the wearable cameras 1101, 1201, and 1601.

When the connection detection unit 1003 detects that the wearable camera 1101 is connected to the interface connector 1010, D+01 and D+10, and D−01 and D−10 are connected, respectively, and the host system 1005 can communicate with a device system 1104. In this case, the host system 1005 performs an authentication process for authenticating the wearable camera 1101 connected to the interface connector 1010 before performing communication with the device system 1104, and starts communication when the authentication process is successful. The authentication process is performed for security reasons, for example, and is executed because it is necessary that image data can only be transferred and viewed between authenticated devices, and the transfer and viewing of image data by other devices that are not authenticated needs to be limited.

When the connection detection unit 1003 detects that the wearable camera 1101 is connected to the interface connector 1010, the host system 1005 sets a delay according to a startup time of the wearable camera 1101 to start the authentication process.

For example, the host system 1005 communicates with the device system 1104, 1204, or 1604, controls settings of the wearable camera 1101, 1201, or 1601, and receives image data captured by the wearable camera 1101, 1201, or 1601.

A pull-down resistor 1019 is provided to set an input voltage of the connection detection unit 1003 to a voltage of a ground portion (GND) when no voltage is applied to VBUS 004. A pull-down resistor 1029 is provided to set an input voltage of the connection detection unit 1003 to a ground portion (GND) voltage when no voltage is applied to VBUS 008. A pull-down resistor 1069 is provided to set an input voltage of the connection detection unit 1003 to a ground portion (GND) voltage when no voltage is applied to VBUS 024.

A switching unit 1018 is a switch for short-circuiting VBUS 001 through VBUS 003 and VBUS 004. A switching unit 1028 is a switch for short-circuiting VBUS 005 through VBUS 007 and VBUS 008. A switching unit 1068 is a switch for short-circuiting VBUS 021 through VBUS 023 and VBUS 024. The switching units 1018, 1028, and 1068 are controlled to be turned on or off by the host system 1005.

Next, components of the wearable cameras 1101, 1201, and 1601 will be described.

The wearable camera 1101 is connected to the docking station 1001 via the interface connector 1110 and the interface connector 1010. When the wearable camera 1101 is connected to the docking station 1001, the wearable camera 1101 and the docking station 1001 can communicate with each other. When the wearable camera 1101 is connected to the docking station 1001, the wearable camera 1101 can receive a power supply from the docking station 1001. In the first embodiment, the interface connector 1110 is a receptacle connector conforming to USB Type-C, for example, and the interface connector 1010 is a plug connector conforming to USB Type-C, for example.

The wearable camera 1201 is connected to the docking station 1001 via the interface connector 1210 and the interface connector 1020. When the wearable camera 1201 is connected to the docking station 1001, the wearable camera 1201 and the docking station 1001 can communicate with each other. When the wearable camera 1201 is connected to the docking station 1001, the wearable camera 1201 can receive a power supply from the docking station 1001. In the first embodiment, the interface connector 1210 is a receptacle connector conforming to USB Type-C, for example, and the interface connector 1020 is a plug connector conforming to USB Type-C, for example.

The wearable camera 1601 is connected to the docking station 1001 via the interface connector 1610 and the interface connector 1060. When the wearable camera 1601 is connected to the docking station 1001, the wearable camera 1601 and the docking station 1001 can communicate with each other. When the wearable camera 1601 is connected to the docking station 1001, the wearable camera 1601 can receive a power supply from the docking station 1001. In the first embodiment, the interface connector 1610 is a receptacle connector conforming to USB Type-C, for example, and the interface connector 1060 is a plug connector conforming to USB Type-C, for example.

FIG. 2B shows an arrangement of pins in a receptacle connector conforming to USB Type-C. In the interface connector 1110, VBUS terminals 1111, 1112, 1113, and 1114 are VBUS terminals conforming to USB Type-C. The VBUS terminals 1111, 1112, 1113, and 1114 are referred to as VBUS 101, VBUS 102, VBUS 103, and VBUS 104 in the first embodiment. A CC terminal 1115 is a CC (Configuration Channel) terminal conforming to USB Type-C, and is referred to as CC 10 in the first embodiment. The D+ terminal 1116 is a D+ terminal for USB communication and is referred to as D+10. A D− terminal 1117 is a D− terminal for USB communication, and is referred to as D−10. Similarly, in the interface connector 1210, VBUS terminals 1211, 1212, 1213, and 1214 are referred to as VBUS 201 through VBUS 204 in the first embodiment. Similarly, in the interface connector 1610, the VBUS terminals 1611, 1612, 1613, and 1614 are referred to as VBUS 601 through VBUS 604 in the first embodiment. CC terminals 1215 and 1615 are referred to as CC 20 and CC 60, respectively, in the first embodiment. D+ terminals 1216 and 1616 are referred to as D+20 and D+60, respectively, in the first embodiment. D− terminals 1217 and 1617 are referred to as D−20 and D−60, respectively, in the first embodiment.

A power source control unit 1102 performs control for supplying power from the docking station 1001 and a battery 1103 to the components of the wearable camera 1101. A power supply control unit 1202 performs control for supplying power from the docking station 1001 and a battery 1203 to the components of the wearable camera 1201. A power supply control unit 1602 performs control for supplying power from the docking station 1001 and a battery 1603 to the components of the wearable camera 1601.

The batteries 1103, 1203 and 1603 are rechargeable batteries such as lithium ion batteries.

The device system 1104 controls the components of the wearable camera 1101. The device system 1204 controls the components of the wearable camera 1201. The device system 1604 controls the components of the wearable camera 1601. The device systems 1104, 1204, and 1604 further have a function for performing authentication process with the docking station 1001 and a function of communicating with the docking station 1001.

The current control unit 1105 sets, to the power source control unit 1102, a current for when a power supply is received from the docking station 1001. The current control unit 1105 is controlled by the device system 1104. A current control unit 1205 sets, to the power supply control unit 1202, a current for when a power supply is received from the docking station 1001. The current control unit 1205 is controlled by the device system 1204. A current control unit 1605 sets, to the power supply control unit 1602, a current for when a power supply is received from the docking station 1001. The current control unit 1605 is controlled by the device system 1604. Details of a current setting method of the current control units 1105, 1205, and 1605 will be described later.

Next, an example of a method by which the docking station 1001 detects that the wearable cameras 1101, 1201, and 1601 are connected to the docking station 1001 will be described.

In the first embodiment, as shown in FIG. 1, one of the pins of VBUS 001 through VBUS 004, which are VBUS terminals of the interface connector 1010, is electrically isolated from the power supply unit 1002 in the docking station 1001. However, it may be multiple pins. In the first embodiment, for example, VBUS 001 through VBUS 003 are short-circuited inside the docking station 1001 and are connected to the power supply unit 1002. Further, VBUS 004 is electrically isolated from the other VBUS 001 through VBUS 003 and is connected to the connection detection unit 1003. In a normal connection, VBUS 001 through VBUS 004 are short-circuited inside the docking station 1001 and connected to the power supply unit 1002.

Next, a method for detecting a connection of the wearable camera 1101 connected by the interface connector 1010 will be described. When the wearable camera 1101 is not connected, the output voltage of the power supply unit 1002 is applied to VBUS 001 through VBUS 003. Meanwhile, the output voltage of the power supply unit 1002 is not applied to VBUS 004 which is electrically isolated from VBUS 001 through VBUS 003. Therefore, the voltage of VBUS 004 is fixed to the ground portion (GND) voltage by the pull-down resistor 1019. When the wearable camera 1101 is connected to the interface connector 1010, the interface connector 1010 and the interface connector 1110 are connected to each other. Then, the voltage of the power supply unit 1002 is applied to VBUS 004 via VBUS 101 through VBUS 104 which are short-circuited in the wearable camera 1101. In the connection detection unit 1003, it can be determined that the wearable camera 1101 is connected by detecting that the voltage of the power supply unit 1002 is applied to VBUS 004.

In the first embodiment, the method for detecting the wearable camera 1101 connected via the interface connector 1010 has been described, but the interface connector 1020 can also detect the wearable camera 1201 in a similar manner. Similarly, the interface connector 1060 can detect the wearable camera 1601.

In the first embodiment, VBUS 005 through VBUS 007 of the interface connector 1020 are short-circuited inside the docking station 1001 and connected to the power supply unit 1002, and VBUS 008 is independently connected to the connection detection unit 1003. For the interface connector 1060, VBUS 021 through VBUS 023 are short-circuited in the docking station 1001 and connected to the power supply unit 1002, and VBUS 024 is independently connected to the connection detection unit 1003.

When the wearable camera 1201 is connected to the interface connector 1020, the interface connector 1020 and the interface connector 1210 are connected. Then, the voltage of the power supply unit 1002 is applied to VBUS 008 via VBUS 201 through VBUS 204 which are short-circuited in the wearable camera 1201. In the connection detection unit 1003, it can be determined that the wearable camera 1201 is connected by detecting that the voltage of the power supply unit 1002 is applied to VBUS 008.

In the interface connector 1060, VBUS 021 through VBUS 023 are short-circuited in the docking station 1001 and connected to the power supply unit 1002, and VBUS 024 is independently connected to the connection detection unit 1003. When the wearable camera 1601 is connected, the interface connector 1060 and the interface connector 1610 are connected. Then, the voltage of the power supply unit 1002 is applied to VBUS 024 via VBUS 601 through VBUS 604 which are short-circuited in the wearable camera 1601. In the connection detection unit 1003, it can be determined that the wearable camera 1601 is connected by detecting that the voltage of the power supply unit 1002 is applied to VBUS 024.

Normally, there are four power supply terminals for supplying power from the power supply unit 1002 to the wearable camera 1101 (VBUS 001 through VBUS 004). In contrast, in the first embodiment, since the number of terminals is reduced to three terminals (VBUS 001 through VBUS 003), there is a possibility that the power that can be supplied will be lower. To correct this the host system 1005 sets the switching unit 1018 to be off until completion of the authentication process, when the wearable camera 1101 is connected. Then, after the authentication process succeeds, the switching unit 1018 may be turned on to short-circuit VBUS 001 through VBUS 003 and VBUS 004, thereby increasing the supplied power. When the switching unit 1018 is turned on, VBUS 001 through VBUS 003 and VBUS 004 are short-circuited, and a power supply can be performed at four terminals as normal.

When the connection between the docking station 1001 and the wearable camera 1101 is disconnected, the host system 1005 may detect the stoppage of the communication with the wearable camera 1101 via D+01 or D−01, and may turn off the switching unit 1018. When the switching unit 1018 is turned off and VBUS 004 is electrically isolated from VBUS 001 through VBUS 003, a connection with the wearable camera 1101 can be detected again. When the output of the power supply unit 1002 is stopped due to an unexpected problem or the like, the host system 1005 may detect the stoppage of the output of the power supply unit 1002 and turn off the switching unit 1018.

Note that control of the switching unit 1028 in the connection between the docking station 1001 and the wearable camera 1201 can be performed in a similar manner to the control of the switching unit 1018 in the connection between the docking station 1001 and the wearable camera 1101. The control of the switching unit 1068 in the connection between the docking station 1001 and the wearable camera 1601 can be performed in a similar manner to the control of the switching unit 1018 in the connection between the docking station 1001 and the wearable camera 1101.

As described above, according to the connection detection method of the first embodiment, detection of a connection of a wearable camera to the docking station can be performed with high accuracy and quickly with a simple configuration.

Here, an example of a method for setting a current for when the current control unit 1105 of the wearable camera 1101 receives a power supply from the docking station 1001 will be described. Note that a method for setting the current when the current control unit 1205 receives a power supply from the docking station 1001 is similar to the method of setting the current for when the current control unit 1105 receives the power supply from the docking station 1001, and therefore the description thereof is omitted. A method for setting the current when the current control unit 1605 receives a power supply from the docking station 1001 is also similar to the method of setting the current for when the current control unit 1105 receives the power supply from the docking station 1001, and therefore the description thereof is omitted.

In the wearable camera 1101, the current control unit 1105 sets a current for when a power supply is received from the docking station 1001 by changing a resistance value connected between the power source control unit 1102 and a ground portion (GND).

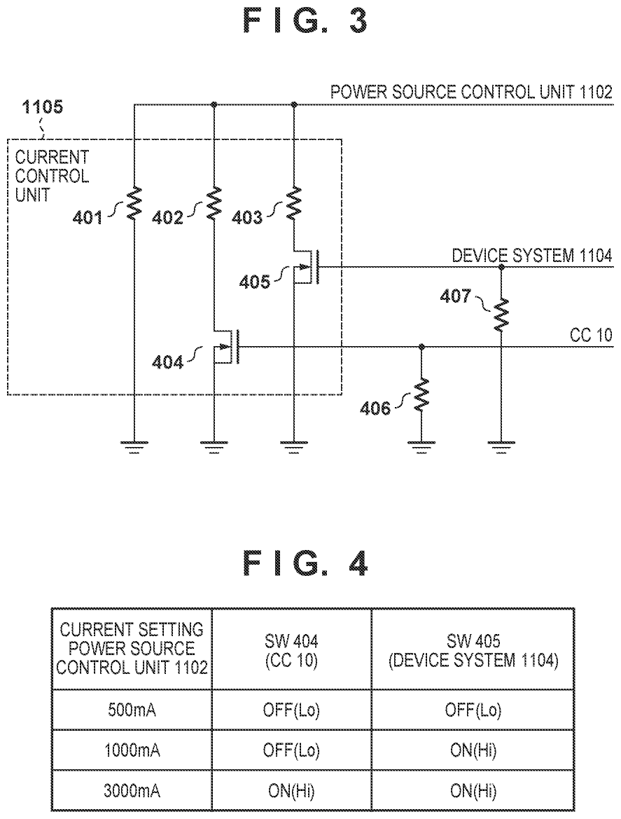

An example of the components of the current control unit 1105 will be described with reference to FIG. 3. In FIG. 3, a resistor 401 is connected between the power source control unit 1102 and a ground portion (GND). A resistor 402 is connected between the power source control unit 1102 and a ground portion (GND) via a SW 404. A resistor 403 is connected between the power source control unit 1102 and a ground portion (GND) via a SW 405. A pull-down resistor 406 is provided to stabilize control of the SW 404. A pull-down resistor 407 is provided to stabilize the control of the SW 405. The SW 404 is controlled by the current control unit 1004 of the docking station 1001 via CC 10. When a Hi signal equal to or higher than a predetermined threshold voltage is inputted from the current control unit 1004, the SW 404 is turned on, and the resistor 402 is connected to the ground portion (GND). The SW 405 is controlled by the device system 1104 of the wearable camera 1101. When a Hi signal equal to or higher than a predetermined threshold voltage is inputted from the device system 1104, the SW 405 is turned on, and the resistor 403 is connected to the ground portion (GND).

An example of a current setting set by the current control unit 1105 will be described with reference to FIG. 4. In FIG. 4, when both the SW 404 and the SW 405 are off, for example, the power source control unit 1102 sets the current for when receiving a power supply from the docking station 1001 to 500 mA (first supply power). When the SW 404 is off and the SW 405 is on, for example, the power source control unit 1102 sets the current for when receiving a power supply from the docking station 1001 to 1000 mA (second supply power). Both 500 mA and 1000 mA are currents corresponding to power that the docking station 1001 can supply to all of the wearable cameras, even if all of the wearable cameras are connected to the docking station 1001.

When both the SW 404 and the SW 405 are on, for example, the power source control unit 1102 sets the current for when a power supply is received from the docking station 1001 to 3000 mA (third supply power). 3000 mA is a current at which power cannot be supplied to all of the wearable cameras if, for example, four or more wearable cameras are connected to the docking station 1001.

The current control unit 1205 has the same configuration as the current control unit 1105, and can set a current for when a power supply is received from the docking station 1001 in a similar manner to the current control unit 1105. The current control unit 1605 has the same configuration as the current control unit 1105, and can set a current for when a power supply is received from the docking station 1001 in a similar manner to the current control unit 1105.

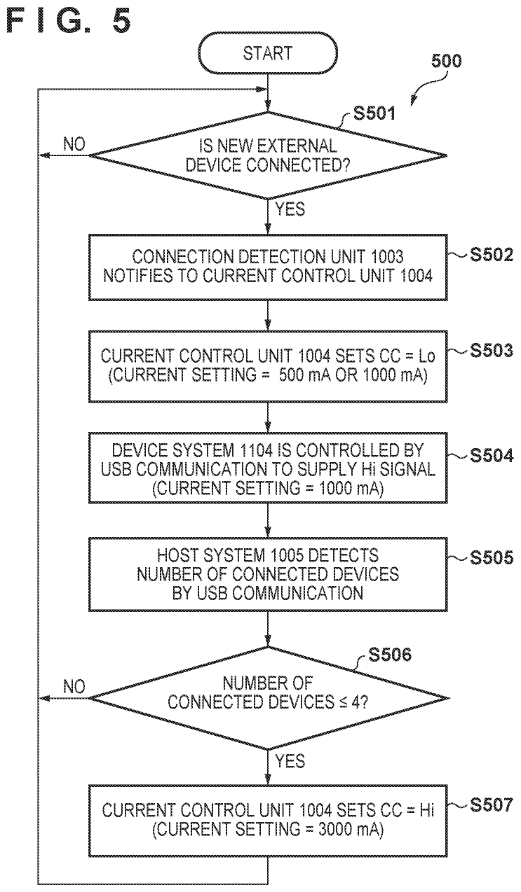

Next, an exemplary process performed by the battery charging system shown in FIG. 1 will be described with reference to the flowchart of FIG. 5. Process 500 illustrates an exemplary process in which the docking station 1001 controls power supplied to one or more connected devices in accordance with the number of external devices connected to the docking station 1001.

The process 500 is controlled by the host system 1005 executing a program stored in a memory (not shown). The process 500 may be started, for example, after the host system 1005 is activated.

In step S501, the host system 1005 determines whether the connection detection unit 1003 has detected that a new external device (one of the wearable cameras 1101, 1201, and 1601) has been connected to the docking station 1001. If the connection detection unit 1003 does not detect that a new external device is connected to the docking station 1001, the process 500 repeats step S501 after a predetermined period of time has elapsed (NO in step S501). If the connection detection unit 1003 detects that a new external device is connected to the docking station 1001, the process 500 advances from step S501 to step S502 (YES in step S501).

In step S502, the connection detection unit 1003 notifies the current control unit 1004 of which of the wearable cameras 1101, 1201, and 1601 is the new external device detected in step S501. Thereafter, process 500 advances from step S502 to step S503.

In step S503, the current control unit 1004 supplies a Lo signal which is lower than a predetermined threshold voltage to all of the external devices connected to the docking station 1001 through CC 01, CC 02, and CC 06. As a result, for the wearable cameras 1101, 1201, and 1601 to which the Lo signal is supplied by the current control unit 1004, the current for when receiving a power supply from the docking station 1001 is limited to 500 mA or 1000 mA. Here, the selection of 500 mA or 1000 mA is a selection according to a current required for USB communication. Thereafter, process 500 advances from step S503 to step S504.

In step S504, the host system 1005 communicates with the new external device detected in step S501. When the new external device detected in step S501 is, for example, the wearable camera 1101, the host system 1005 controls the device system 1104 to supply the Hi signal, which is a voltage equal to or higher than a predetermined threshold, to the current control unit 1105. As a result, the current for when the wearable camera 1101 receives a power supply can be increased from 500 mA to 1000 mA. Thereafter, process 500 advances from step S504 to step S505.

In step S505, the host system 1005 detects the number of external devices connected to the docking station 1001 by communicating with all external devices connected to the docking station 1001. After detecting the number of external devices connected to the docking station 1001, the process 500 advances from step S505 to step S506.

In step S506, the host system 1005 determines whether or not the number of external devices connected to the docking station 1001 is equal to or less than a predetermined number (e.g., 4). If the number of external devices connected to the docking station 1001 is less than or equal to the predetermined number, the process 500 advances from step S506 to step S507 (YES in step S506).

In step S507, the host system 1005 controls the current control unit 1004 to supply a Hi signal equal to or higher than the threshold voltage to all of the external devices connected to the docking station 1001. This allows a current for when the external devices connected to the docking station 1001 receives a power supply to be increased from 1000 mA (second supply power) to 3000 mA.

On the other hand, if the number of external devices connected to the docking station 1001 exceeds the predetermined number (e.g., 4), the process 500 advances from step S506 to step S501 (NO in step S506). At this time, as controlled in step S503, the current control unit 1004 maintains a state in which the Lo signal which is lower than the predetermined threshold voltage is supplied to the external devices connected to the docking station 1001 via the CC 01, the CC 02, and the CC 06. This allows the current for when the external devices connected to the docking station 1001 receive a power supply to be maintained at 1000 mA.

Note that in the first embodiment, the predetermined number is described as 4, but the predetermined number is determined in accordance with the power supply capability of the power supply unit 1002, and is not limited to 4.

As described above, by virtue of the first embodiment, the docking station 1001 can detect external device connections. In addition, power supplied to one or more connected devices can be adjusted without exceeding a power supply capability of the docking station 1001 when a new external device is connected.

Note that embodiments of the disclosure are not limited to the first embodiment described above. Changes or revisions made to the first embodiment of the disclosure within a scope of the disclosure are included in embodiments of the disclosure.

### Second Embodiment

Various kinds of functions, processes, or methods described in the first embodiment can also be achieved by a personal computer, a microcomputer, a CPU (Central Processing Unit), or the like using a program. In a second embodiment, a personal computer, a microcomputer, a CPU, or the like will be called a “computer X” below. Also, in the second embodiment, a program for controlling the computer X and achieving various kinds of functions, processes, or methods described in the first embodiments will be called a “program Y”.

Various kinds of functions, processes, or methods described in the first embodiment is achieved by the computer X executing the program Y. In this case, the program Y is supplied to the computer X via a computer-readable storage medium. The computer-readable storage medium according to the second embodiment includes at least one of a hard disk device, a magnetic storage device, an optical storage device, a magneto-optical storage device, a memory card, a volatile memory (e.g., random access memory), a non-volatile memory (e.g., read only memory), or the like. The computer-readable storage medium according to the second embodiment is a non-transitory storage medium.

While aspects of the disclosure are described with reference to exemplary embodiments, it is to be understood that the aspects of the disclosure are not limited to the exemplary embodiments. The scope of the following claims is to be accorded the broadest interpretation so as to encompass all modifications and equivalent structures.

This application claims priority from Japanese Patent Application No. 2018-126358, filed Jul. 2, 2018, which is hereby incorporated by reference herein in its entirety.

What is claimed is:

1. An electronic device comprising:
an interface unit to which external devices can be connected; and
a control unit that (i) sets power to a second power greater than a first power after limiting power supplied to the external device to the first power, (ii) maintains power supplied to the external device at the second power, in a case where the number of the external devices connected to the interface unit exceeds a predetermined number, and (iii) controls power supplied to the external device to be a third power greater than the second power, in a case where the number of the external devices connected to the interface unit is not the predetermined number.

2. The electronic device according to claim 1, further comprising
a communication unit that communicates with the external device connected to the interface unit,
wherein the control unit determines the number of the external devices connected to the interface unit by the communication unit.

3. The electronic device according to claim 1, further comprising
a current control unit that controls a current for when supplying power to the external device,
wherein the external device includes a setting unit that sets a current for when receiving a power supply from the electronic device, and a power source control unit that receives the power supply from the electronic device at the set current,
wherein of the setting unit is controlled by the current control unit and the external device to set a current for when receiving the power supply from the electronic device.

4. The electronic device according to claim 3, wherein the setting unit has switch units for changing a current for when the power source control unit receives power supply,
wherein of the switch units are controlled by the current control unit and the external device.

5. The electronic device according to claim 1, wherein the first power and the second power are powers that can be supplied to the external devices even if the maximum number of external devices that can connect to the electronic device are connected to the electronic device.

6. The electronic device according to claim 5, wherein the third power is a power that cannot be supplied to the external devices if the maximum number of external devices that can connect to the electronic device are connected to the electronic device.

7. The electronic device according to claim 1, wherein the external device outputs a signal to a power supply terminal of the interface unit in a case where the external device is connected by short-circuiting a terminal connected to the power supply terminal of the interface unit.
